(19) United States
(12) Patent Application Publication
(10) Pub. No.: US 2012/0042286 A1
(43) Pub. Date: Feb. 16, 2012

(54) Graphical Computer Application Recall System and Method

(75) Inventors: Michael Patrick Sullivan, Chandler, AZ (US); Justin Cade Dyster, Chandler, AZ (US)

(73) Assignee: RMT, INC., Tempe, AZ (US)

(21) Appl. No.: 13/206,000

(22) Filed: Aug. 9, 2011

Related U.S. Application Data
(60) Provisional application No. 61/372,211, filed on Aug. 10, 2010.

(51) Int. Cl. G06F 3/048

(52) U.S. Cl. 715/835

(57) ABSTRACT

A method for recalling application programs in a computer having a memory includes accepting a first user input for indicating a program configuration of application programs running on the computer and storing the program configuration in the memory in association an icon to provide a stored program configuration. The icon is displayed and a second user input for indicating the icon is accepted. The application programs of the stored program configuration are launched in response to the second user input. A further program configuration of application programs running on the computer in the memory is stored in association with a further icon to provide a further stored program configuration, and a further user input for selecting either the icon or the further icon is accepted. The application programs of either the stored program configuration or the further stored program configuration are selectively launched in response to the second user input.

### FIELD OF THE INVENTION

The invention relates generally to the field of graphical user interfaces for computer systems and in particular to storage and recall of programs operating in a multi-tasking system.

### BACKGROUND OF THE INVENTION

Computing systems and computer operating system software allowing multiple programs (commonly termed application programs) to operate simultaneously are well known. For example, the Windows® operating system allows personal computer users to have a plurality of application programs open and running at the same time. Often multiple application programs are portrayed in portions of a viewing screen, while it is also possible to display one application program while others that are open are noted in small indications on the screen such as icons or text indications.

While users may have various sets of application programs open for particular tasks, once the computer is shutdown, their configuration is lost. It is desirable to be able to subsequently recreate the configuration of running application programs without having to individually open them. In other situations, it is desirable to switch between sets of running application programs depending on the tasks the user is performing at a particular time, and to recall the position on the screen of the application programs. The need for recalling sets and positions of open application programs addresses two issues—time and repeatability. It takes time for a user to “set up” their computer to perform a specific set of application programs. Also, being able to repeat a previous combination of application programs relieves the user of the burden of remembering which application programs were open.

In many cases, portable personal computers are now used for specific uses in field situations. Such uses include law enforcement, military uses, commercial field testing, surveying, inventory control, vehicle and site inspections and the like. In these cases, time is often critical and the computers are often used with the same sets of application programs for a specific purpose. For example, a police officer may have a particular set of programs open while in a patrol car and a different set open when preparing reports in the station. The ability to quickly store and recall often-used application program configurations saves the user time and increases productivity.

One known application for Windows® operating software, called CacheMyWork, identifies all the application programs that the user has launched and that are visible on the task bar. The user selects those application programs to be saved for a future use. CacheMyWork writes values to the Windows® registry which affects the programs launched by Windows® at startup. A description of this product is described at http:/cachemywork/codeplex.com.

CacheMyWork can enable a user to instruct Windows® to re-launch specific application the next time the user logs in, and to identify the application the user has launched and are visible on the task bar. In can also simplify the list by removing the applications that are auto-started by Windows® on behalf of the user. The user can then select any applications that the user wants to launch after the logon.

Using the Tools>Hide Applications menu the user can select active applications to be hidden from the main list that is displayed when CacheMyWork is first launched. Previously hidden applications can be selected for display on the main list. Furthermore, the Windows® setting “Restore previous Explorer windows at next logon” can be enabled or disabled. This Windows® setting will cause each Explorer window (e.g. drive, folder, share) to be opened again to the same location at the next logon. This Windows® setting is persistent—i.e. it will not require the user to run CacheMyWork before each reboot (i.e. it is not a CacheMyWork feature).

Caching/reboot-friendly applications are applications that have specific ability to automatically re-open the documents that were open when the application was last closed. On such application is a free open source replacement for Notepad that will automatically remember and re-open any files that were open when the application last closed or crashed. Another is Avant Browser or Maxthon Browser which are free closed source replacements (Trident wrappers, actually) for Internet Explorer. These browser enhancements use the Internet Explorer engine to provide the same page layout and compatibility with IE-friendly sited, by replace the user interface with new menus, right-click options, tabbing, caching of open tabs, and other features. Another is Firefox with the Session Manager add-on. The application saves multiple open tabs and windows, whether it is closed correctly or it crashes. It can also save a history of closed windows until Firefox closes (or even across launches).

However, CacheMyWork does not re-launch any programs directly, it only provides a “list” to Windows® to be launched at reboot by Windows®. One of the limitations of CacheMyWork is that it saves only one application program configuration. It also does not allow the user to save and recall multiple configurations. CacheMyWork only restores the configuration on boot-up, not at the user's command. CacheMyWork does not restore the size and placement of applications and does not restore multiple instances of applications.

Thus, CacheMyWork only caches applications, not their documents. It is not able to save and automatically re-open the open documents for most applications, except where those applications happen to store the documents' filename and path on the processes' command line, such as with Notepad. Furthermore, CacheMyWork is only able to cache the first instance of each application that it finds. If there are two or more of any on application running at once (e.g. when Notepad is launched twice, CacheMyWork in not able to cache the second instance of the application.

Thus, a need exists for a graphical user interface tool for memorizing a specific configuration of executing applications and for selectively recalling the configuration from among multiple such configurations.

All citations are incorporated herein by reference.

### SUMMARY OF THE INVENTION

A method for recalling application programs in a computer having a memory includes accepting a first user input for indicating a program configuration of application programs running on the computer and storing the program configuration in the memory in association an icon to provide a stored program configuration. The icon is displayed and a second user input for indicating the icon is accepted. The method also includes launching the application programs of the stored program configuration in response to the second user input.

A further program configuration of application programs running on the computer in the memory is stored in association with a further icon to provide a further stored program configuration, and a further user input for selecting either the icon or the further icon is accepted. The application programs of either the stored program configuration or the further stored program configuration are selectively launched in response to the second user input. The application programs can include a plurality of instances of an application program and the plurality of instances of the application is launched in response to the second user input. Launching a selected application program includes opening a document of the selected application in the state of the document at the time of the first user input. The document is cached in a non volatile memory at the time of the first user input.

The system and method of the invention can also include detecting a user request for a shutdown of the computer and prompting the user for the first user input prior to the requested shutdown. It can also include accepting the first user input before a shutdown and accepting the second user input and launching the application programs after a subsequent boot up. The computer displays representations of the application programs in response to a user interaction with the icon, and the program configuration can include an on screen size of an application program of the application programs and an on screen location of an application program of the application programs. The icon and the further icon comprise quadrants of a visual display.

A system and method for recalling computer application programs is disclosed. The method includes displaying a number of icons associated with potential stored program configurations, accepting user input for which icon stores the current configuration, and storing the current configuration of running application programs and their on-screen sizes and positions. Displaying stored configurations as icons showing the stored configuration at the time of storage, and accepting user input as to a stored configuration and launching the programs stored in the stored configuration are also included.

### DESCRIPTION OF THE DRAWINGS

FIG. 1 is a representation of an initial computer screen in an exemplary application for storage of application configurations;

FIG. 2 is a representation of a computer screen showing a single stored preset configuration in the exemplary application shown in FIG. 1;

FIG. 3 is a representation of a computer screen after the configuration shown in FIG. 2 has been restored;

FIG. 4 is a representation of the screen of FIG. 2 with an application list that appears when an on-screen cursor is placed over the depiction of the saved configuration;

FIG. 5 is an exemplary flow chart for a method of storing configurations of application programs; and

FIG. 6 is an exemplary flow chart for a method of restoring configurations of application programs.

### DESCRIPTION OF THE PREFERRED EMBODIMENT OF THE INVENTION

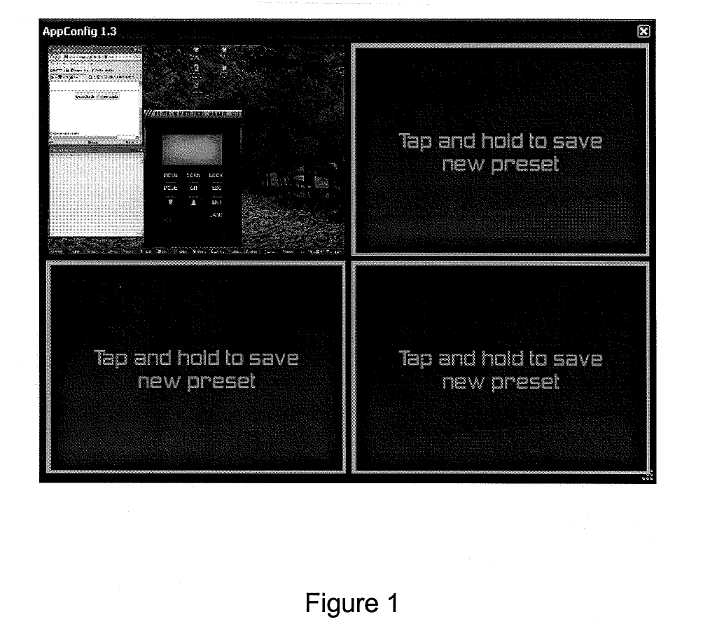

The invention will be described with respect to FIGS. 1-6. It will be understood that the embodiments discussed in this application and depicted in the figures are for illustrative purposes only. Those having skill in the computing arts will understand that modifications and alterations can be made hereto within the spirit of the invention.

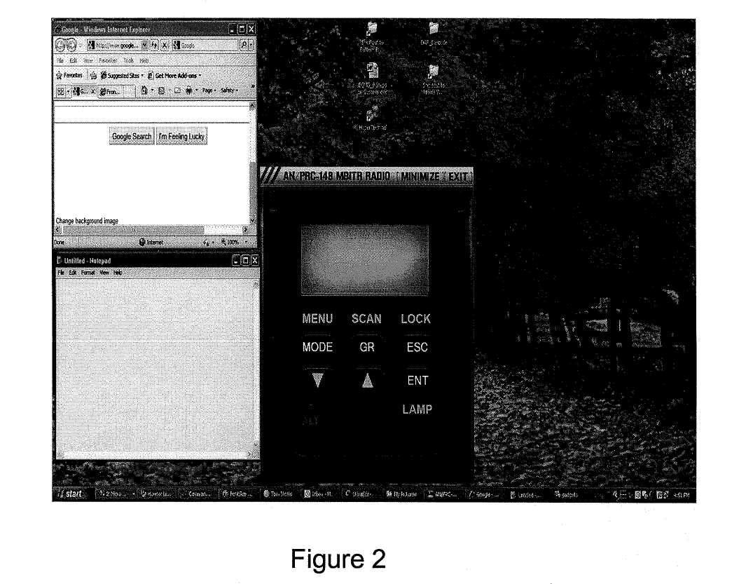

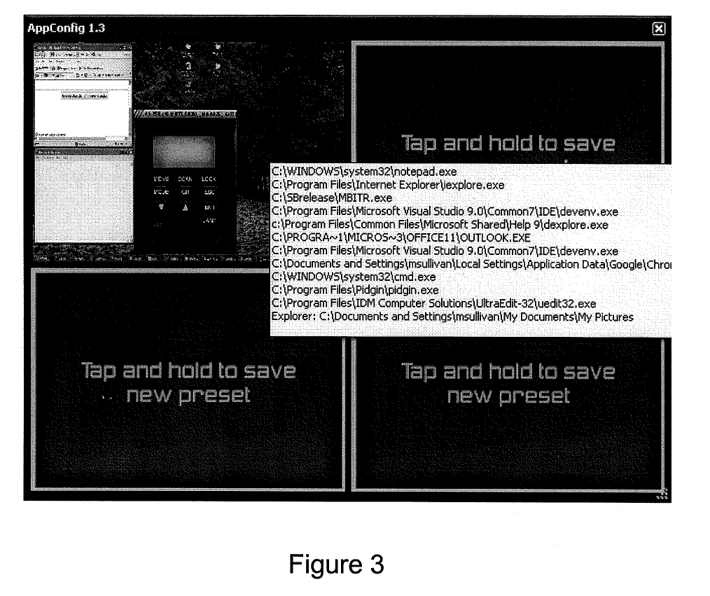

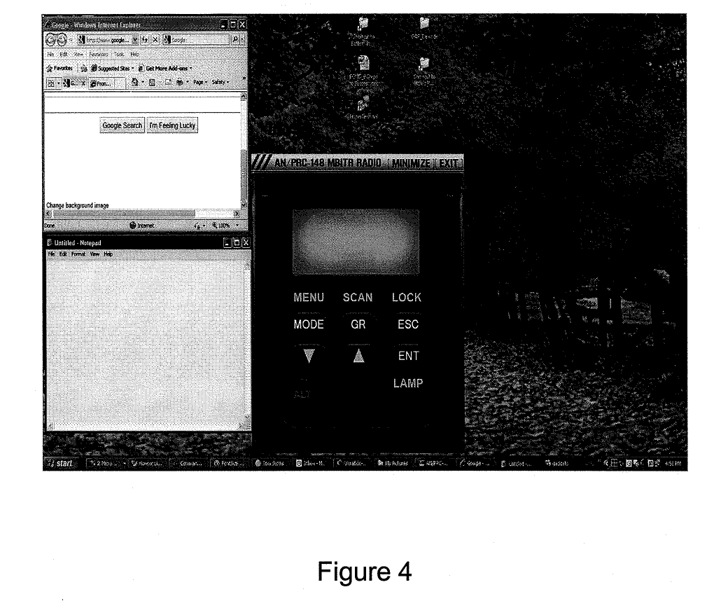

FIG. 1 shows a computer screen that appears when an exemplary program to save application program configurations is initialized. In this embodiment, there is space for saving up to four configurations. If the user actuates one of the four quadrants, either by clicking a mouse button with the cursor over the quadrant, or, in a touch screen system, tapping and holding the screen in one of the quadrants, the current configuration of application programs will be stored. FIG. 2 shows the computer screen when the exemplary program has one stored application configuration. If the user activates that configuration either with a mouse or touch screen entry, the depicted configuration of application programs will be launched. FIG. 3 shows the computer screen while the user hovers a cursor over the upper left quadrant. The screen shows a superimposed box with the list of application programs that will be launched if that configuration is invoked. FIG. 4 shows the computer screen after the stored configuration of applications shown in FIGS. 2 and 3 is invoked.

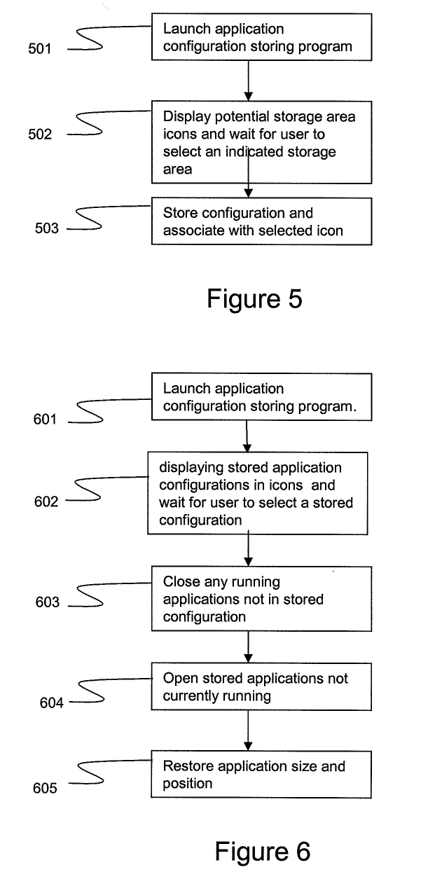

FIG. 5 shows exemplary steps for storing a configuration of application programs running on a computer system. At step 501, the application configuration storing program is launched. At step 502, the program displays storage area icons where the user could chose to store the current application program configuration. At step 503, after the user has selected a storage icon, the configuration is stored and associated with the selected icon. Storage of the configuration includes the size and on-screen location of each of the applications and all of the state information necessary about each application for it to be re-launched in the same state at a later time.

FIG. 6 shows exemplary steps for restoring a previously stored configuration of applications from among a potential of more than one stored configuration. At step 601, the application restoration program is launched and icons depicting stored configurations are displayed. Note that these icons, when stored, represent the appearance of the screen at the time that the configuration was stored. This gives the user the advantage of instant recognition of the stored configuration. At step 602, the stored configuration icons are displayed. At step 603, after the user has selected a configuration, any running applications that are not listed in the stored configuration are closed. At step 604, the applications that are listed in the stored configuration that were not already running are launched. At step 605, the application sizes and screen positions are set to match the stored sizes and positions.

In an exemplary embodiment of the system on which the described program runs, the computer system is a Windows® operating system compatible personal computer having a graphical user interface, a system processor, system memory, user input keys and a screen pointing input device. The screen pointing input device can be a mouse associated with a cursor, a track ball associated with a cursor, a loose or stiff joystick associated with a cursor, or a touch screen monitor that positions a cursor or accepts a screen position indication in the screen location where the user touches the screen. In a further embodiment, the computer is a self contained portable unit having a touch panel display screen, keypad input, processor and memory in a single device.

Thus, the invention allows the user to save multiple configurations rather than saving only one configuration. Additionally, the invention allows the user to recall any saved configuration at any time. It is not limited to only restoring its list at the time of Windows® boot-up. It displays a visual cue (screenshot) for the user that represents the saved configuration or configurations. Furthermore, it restores the size and placement of the applications, and it restores multiple instances of applications (i.e. two Notepad windows). The GUI of the invention can have two modes: a full mode with the screenshot-buttons, and a minimized mode to the system tray where you can access it using a right click.

The exemplary embodiments discussed above are not intended to limit the scope of the invention. Various implementations are possible and would be within the grasp of one skilled in the art. Alternate implementations include but are not limited to, storing and displaying configuration icons on separate miniature screens apart from the main screen, each screen acting as a single button to be actuated to store or recall the depicted configuration. In an alternate embodiment, the configuration icons are stored on the main screen but are small icons so that a majority portion of the main screen still shows the currently running application programs. In an alternate embodiment, the user is asked when shutting down the computer which of the stored configurations, if any, should be launched the next time the computer is turned on. In an alternate embodiment, the configuration is stored as a file and the user can load that file onto another computer and launch the same programs that were launched on the first computer.

1. A method for recalling application programs in a computer having a memory, comprising:
accepting a first user input for indicating a program configuration of application programs running on the computer;
storing the program configuration in the memory in association an icon to provide a stored program configuration;
displaying the icon;
accepting a second user input for indicating the icon; and
launching the application programs of the stored program configuration in response to the second user input.

2. The method for recalling application programs of claim 1, further comprising:
storing a further program configuration of application programs running on the computer in the memory in association with a further icon to provide a further stored program configuration;
accepting a further user input for selecting either the icon or the further icon; and
selectively launching the application programs of the stored program configuration or the further stored program configuration in response to the second user input.

3. The method for recalling application programs of claim 1, wherein the application programs include a plurality of instances of an application program further comprising launching the plurality of instances of the application in response to the second user input.

4. The method for recalling application programs of claim 1, wherein launching a selected application program comprises opening a document of the selected application in the state of the document at the time of the first user input.

5. The method for recalling application programs of claim 4, further comprising caching the document in a non volatile memory at the time of the first user input.

6. The method for recalling application programs of claim 1, further comprising:
detecting a user request for a shutdown of the computer; and
prompting the user for the first user input prior to the requested shutdown.

7. The method for recalling application programs of claim 1, further comprising:
accepting the first user input before a shutdown; and
accepting the second user input and launching the application programs after a subsequent boot up.

8. The method for recalling application programs of claim 1, further comprising displaying representations of the application programs in response to a user interaction with the icon.

9. The method for recalling application programs of claim 1, wherein the program configuration comprises an on screen size of an application program of the application programs.

10. The method for recalling application programs of claim 1, wherein the program configuration comprises an on screen location of an application program of the application programs.

11. The method for recalling application programs of claim 3, wherein the icon and the further icon comprise quadrants of a visual display.
